(19) United States
(12) Patent Application Publication
(10) Pub. No.: US 2013/0072224 A1
(43) Pub. Date: Mar. 21, 2013

(54) INFORMATION PROCESSING APPARATUS, INFORMATION PROCESSING METHOD, AND COMPUTER PROGRAM PRODUCT

(71) Applicant: Ryunosuke ODA, Tokyo (JP)

(72) Inventor: Ryunosuke ODA, Tokyo (JP)

(73) Assignee: Sony Corporation, Tokyo (JP)

(21) Appl. No.: 13/587,974

(22) Filed: Aug. 17, 2012

(30) Foreign Application Priority Data
Sep. 16, 2011 (JP) 2011-202667

(51) Int. Cl. H04W 24/00

(52) U.S. Cl. 455/456.1

(57) ABSTRACT

An information processing apparatus, method and computer program product estimate position information of the information processing apparatus. A positioning unit determines a position. A storage unit stores positional information obtained by the positioning unit. An estimating unit estimates, when it is determined that the positioning unit does not receive information to perform positioning, an estimated distance of a movement in a first period T1 in which the positioning is not performed. A controller updates the positional information stored in the storage unit when the estimated distance exceeds a threshold value corresponding to the first period T1.

### BACKGROUND

The present disclosure relates to information processing apparatuses, information processing methods, and computer program product. Specifically, the present disclosure relates to an information processing apparatus, an information processing method, and a computer program product which are used to obtain and record positional information.

In general, positional information to be used is obtained using a GPS (Global Positioning System). For example, such a technique has been employed in car navigation systems which are mounted on cars and which lead ways. Furthermore, in recent years, digital still cameras which receive signals from the GPS and obtain and store positional information so as to specify shooting locations have been used.

However, it is not ensured that signals supplied from the GPS are obtained in any positions. In buildings and tunnels, for example, signals supplied from the GPS may not be received, and therefore, positional information may not be obtained. To address this problem, Japanese Unexamined Patent Application Publication No. 2010-145180 proposes autonomous positioning using a geomagnetic sensor and an acceleration sensor. Furthermore, Japanese Unexamined Patent Application Publication No. 2010-62704 proposes a technique of reading, when positional information is not obtained from the GPS since a signal is not supplied from the GPS, positional information stored in a recording medium and using the read positional information.

### SUMMARY

Even when positional information is not obtained, positional information may be compensated for by performing autonomous positioning as disclosed in Japanese Unexamined Patent Application Publication No. 2010-145180. However, accuracy of the autonomous positioning is lower than that of positioning performed by the GPS. When a traveling distance obtained while positional information is not obtained becomes large, for example, it is likely that an error generated in the autonomous positioning becomes large. Therefore, even if the positional information is compensated for, the error may become large and accuracy of the positional information may be low.

Similarly, in Japanese Unexamined Patent Application Publication No. 2010-62704, the larger a traveling distance obtained while positional information is not obtained becomes, the larger a difference between the positional information and positional information recorded in a recording medium becomes. Therefore, even if the positional information is compensated for, the accuracy of the positional information is low.

Accordingly, it is desirable not to employ positional information of low accuracy and it is desirable to improve accuracy of positional information to be recorded.

According to an embodiment of the present technique, there is provided an information processing apparatus including a positioning unit configured to measure a position of the information processing apparatus, a storage unit configured to store positional information obtained by the positioning unit, an estimating unit configured to estimate, when it is determined that the positioning unit does not perform positioning, a distance of a movement in a first period in which the positioning is not performed, and a controller configured to perform, when a determination as to whether the distance estimated by the estimating unit exceeds a threshold value corresponding to the first period is made and it is determined that the distance exceeds the threshold value, control such that the latest positional information stored in the storage unit is removed from the storage unit.

The estimating unit may calculate a value of a difference between a first position represented by positional information stored at a first time point when the positioning performed by the positioning unit is stopped and a second position represented by positional information stored at a second time point which comes before the first time point by a second period, the second period being associated with a traveling speed at the first time point, and calculate an average speed by dividing the difference value by a difference between the first and second time points. The average speed may be multiplied by the first period so that the distance is estimated.

The difference value may be obtained by calculating a distance obtained by connecting the first and second positions by a straight line as the difference value or by adding differences among positions corresponding to positional information stored in a period of time from the first time point to the second time point to one another.

A plurality of modes may be set depending on a traveling speed and different second periods are set for the individual modes. The estimating unit may determine a mode corresponding to a traveling speed at the first time point and estimates the distance using the second period set in the mode.

When it is determined that the distance does not exceed the threshold value, the latest positional information stored in the storage unit may be stored in the storage unit as positional information obtained in the first period.

The threshold value may be obtained by multiplying a preset speed by the first period.

The threshold value may be a value of a difference between a first position represented by positional information stored at a first time point when the positioning is not performed by the positioning unit and a second position represented by positional information stored at a second time point which comes before the first time point by the first period.

The difference value may be obtained by calculating a distance obtained by connecting the first and second positions by a straight line as the difference value or by adding differences among positions corresponding to positional information stored in a period of time from the first time point to the second time point to one another.

The controller may remove the latest positional information from the storage unit when the first period becomes equal to or larger than a predetermined value.

The controller may remove, when it is determined that positional information at a time point tracing back from the first time point by the first period has not been stored in the storage unit, the latest positioning information stored in the storage unit.

According to another embodiment of the present technique, there is provided an information processing method including measuring a position of the information processing apparatus, storing obtained positional information, estimating, when it is determined that the positioning unit does not perform positioning, a distance of a movement in a first period in which the positioning is not performed, and removing, when a determination as to whether the distance exceeds a threshold value corresponding to the first period is made and it is determined that the distance exceeds the threshold value, the latest positional information from the storage unit.

A program which causes a computer to execute measuring a position of the information processing apparatus, storing obtained positional information, estimating, when it is determined that the positioning unit does not perform positioning, a distance of a movement in a first period in which the positioning is not performed, and removing, when a determination as to whether the distance exceeds a threshold value corresponding to the first period is made and it is determined that the distance exceeds the threshold value, the latest positional information from the storage unit.

According to the information processing apparatus, the information processing method, and the program of the present technique, position of the information processing apparatus is measured and information on the position is stored. When it is determined that positioning is not performed, a distance of a movement in a period of time in which the positioning is not performed is estimated. When it is determined that the distance exceeds a threshold value corresponding to a first period, the latest positional information is removed from the storage unit.

Accordingly, when positional information is not obtained and therefore positional information is to be compensated for, positional information of low accuracy is prevented from being employed and accuracy of positional information to be recorded is improved.

### BRIEF DESCRIPTION OF THE DRAWINGS

FIG. 1 is a diagram illustrating a configuration of an information processing apparatus according to an embodiment of the present technique;

FIG. 2 is a diagram illustrating a function of the information processing apparatus;

FIG. 3 is a flowchart illustrating operation of the information processing apparatus;

FIG. 4 is a flowchart illustrating a process performed while positioning is not performed;

FIG. 5 is a diagram illustrating a traveling path distance;

FIG. 6 is a diagram illustrating the relationship between a time and a position obtained while the positioning is performed and the relationship between a time and a position obtained while the positioning is not performed;

FIG. 7 is a diagram illustrating a screen;

FIG. 8 is a diagram illustrating another screen;

FIG. 9 is a flowchart illustrating operation of the information processing apparatus;

FIG. 10 is a diagram illustrating another configuration; and

FIG. 11 is a diagram illustrating a recording medium.

### DETAILED DESCRIPTION OF EMBODIMENTS

An embodiment of the present disclosure will be described hereinafter with reference to the accompanying drawings.

### Configuration of Information Processing Apparatus

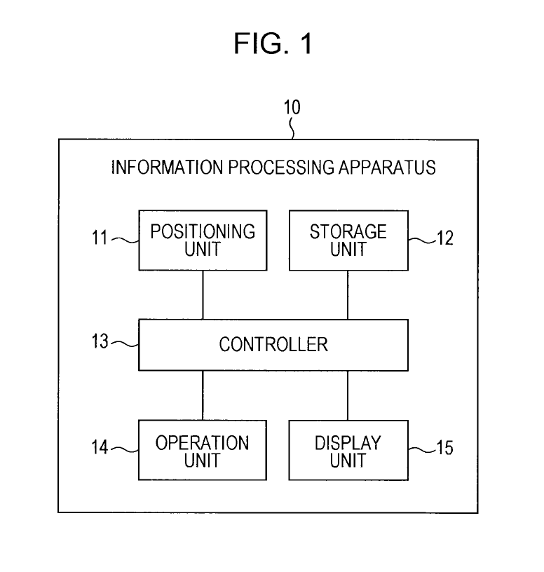

FIG. 1 is a diagram illustrating a configuration of an information processing apparatus according to an embodiment of the present technique. An information processing apparatus 10 illustrated in FIG. 1 includes a positioning unit 11, a storage unit 12, a controller 13, an operation unit 14, and a display unit 15.

The information processing apparatus 10 has a function of performing positioning using a GPS (Global Positioning System) and performing a storing operation. The information processing apparatus 10 may be used as an apparatus which functions as a guide and which is referred to as a navigation system. Furthermore, the information processing apparatus 10 may be incorporated in an image pickup apparatus such as a camera so as to obtain and record a shooting position.

The positioning unit 11 performs positioning using the GPS and supplies an obtained positioning result (hereinafter referred to as “positional information” where appropriate) to the storage unit 12. The positional information includes latitude and longitude. Furthermore, the positioning unit 11 may obtain a traveling speed of the information processing apparatus 10 and a time point included in a signal supplied from the GPS and supply the traveling speed and the time point to the storage unit 12. The storage unit 12 associates the positional information supplied from the positioning unit 11 and an obtainment time point with each other and stores the positional information and the obtainment time point. The obtainment time point may be the time point included in the signal supplied from the GPS or may be an elapsed time from when the positioning is started as described below.

Furthermore, the positioning unit 11 obtains the positional information by measuring a position of the information processing apparatus 10 using the signal supplied from the GPS in this embodiment. However, the positional information may be obtained using other items. For example, the information processing apparatus 10 may be employed in a cellular phone. In a case of the cellular phone, the positional information may be obtained from a base station of the cellular phone.

The controller 13 controls the units included in the information processing apparatus 10. The operation unit 14 functions as a user interface and includes buttons which accept user's instructions. The display unit 15 provides information for a user. When the display unit 15 includes a touch panel, the display unit 15 is integrated with the operation unit 14. A user's instruction issued by operating the operation unit 14 is supplied to the controller 13 which performs a process corresponding to content of the instruction.

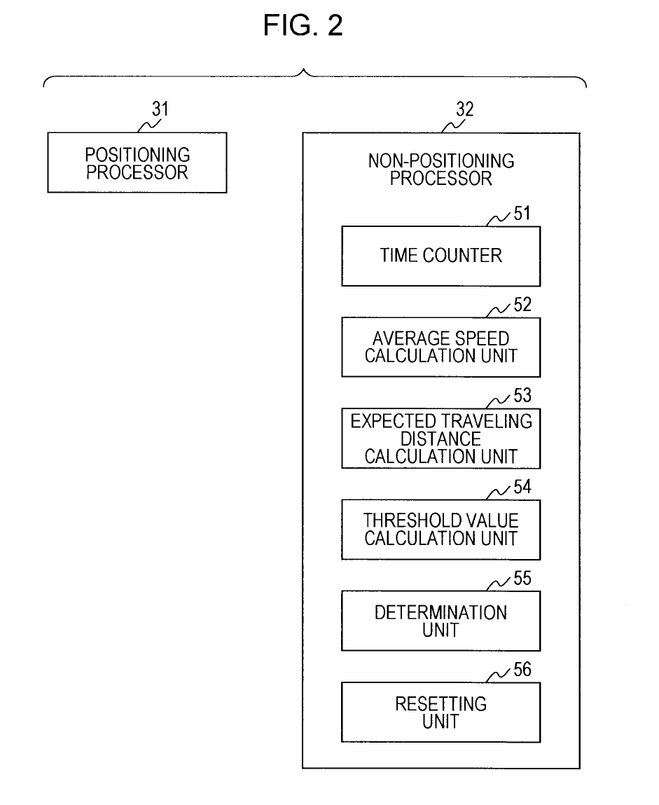

FIG. 2 is a diagram illustrating a function realized in the information processing apparatus 10 when a program stored in the storage unit 12 is executed and the controller 13 performs control in accordance with the program. The information processing apparatus 10 includes a positioning processor 31 which performs a process while the positioning unit 11 appropriately performs positioning and a non-positioning processor 32 which performs a process while the positioning unit 11 does not appropriately perform positioning. The non-positioning processor 32 includes a time counter 51, an average speed calculation unit 52, an expected traveling distance calculation unit 53, a threshold value calculation unit 54, a determination unit 55, and a resetting unit 56. Processes performed by the units will be described hereinafter.

### Operation of Information Processing Apparatus

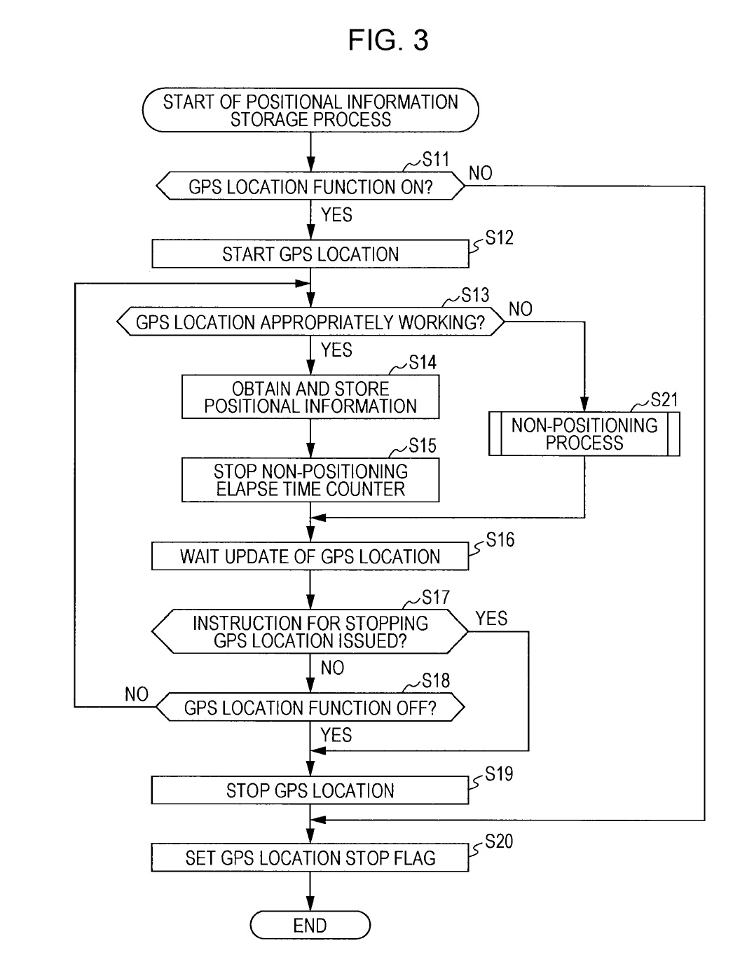

Operation of the information processing apparatus 10 will now be described. A flowchart of FIG. 3 illustrates a process started when the information processing apparatus 10 is powered. In step S11, it is determined whether a GPS location function is an on state. The controller 13 determines whether the location function of the positioning unit 11 is in an on state when the information processing apparatus 10 is powered. When the determination is affirmative in step S11, the process proceeds to step S12. In step S12, the positioning unit 11 starts GPS location. The term “GPS location” represents an obtainment of a signal from a GPS satellite and a calculation of latitude and longitude of a location of the information processing apparatus 10 using the signal supplied from the GPS satellite.

In step S13, it is determined whether the positioning of the GPS location is appropriately performed. The positioning using the GPS is performed by receiving a signal from a satellite. Since it is difficult to receive a signal from a satellite in a building or a tunnel, it is likely that an appropriate positioning is not performed. Therefore, in step S13, it is determined whether a signal is appropriately received from a satellite and whether positioning is appropriately performed. When the determination is affirmative in step S13, the process proceeds to step S14. Accordingly, the process is performed by the positioning processor 31 when the positioning is appropriately performed.

In step S14, a result (positional information) of the positioning performed by the positioning unit 11 is supplied to the storage unit 12 which stores the positional information. In this case, a time point when the positional information is obtained and a traveling speed of the information processing apparatus 10 may be stored after being associated with each other. Furthermore, the storage unit 12 may be configured as a ring buffer, and the positional information and the obtainment time point may be further written in the ring buffer after being associated with each other. Note that, in this embodiment, a description will be made provided that the obtainment time point does not correspond to a time point obtained from the signal supplied from the GPS but a period of time elapsed after the power is on is used as a time stamp and the time stamp is stored after being associated with at least the positional information.

In step S15, a non-positioning elapse time counter is stopped. Although the non-positioning elapse time counter will be described hereinafter in detail, the non-positioning elapse time counter starts counting at a time when the positioning unit 11 enters a state in which the positioning is not appropriately performed. This time counting is performed by the time counter 51. In step S15, the time counting performed by the time counter 51 is stopped.

In step S16, update of the GPS location is waited (a waiting state is entered) and the process proceeds to step S17. In step S17, it is determined whether a request for stopping the GPS location is issued. When the user operates the operation unit 14 so as to instruct stop of the positioning performed by the positioning unit 11, it is determined that the request for stopping the GPS location is issued in step S17 and the process proceeds to step S19. On the other hand, when it is determined that the request for stopping the GPS location is not issued in step S17, the process proceeds to step S18.

In step S18, it is determined whether the GPS location function is in an off state. When the determination is affirmative in step S18, the process proceeds to step S19. In step S19, the GPS location is stopped. That is, in this case, since it is determined that the user issues the request for stopping the GPS location in step S17 or it is determined that the GPS location function is in the off state in step S18, the positioning process performed by the positioning unit 11 is stopped. Thereafter, the process proceeds to step S20.

An operation in step S20 is also performed when it is determined that the GPS location function is not in the on state, that is, the GPS location function is in the off state, in step S11. In step S20, a GPS location stop flag is set. When the GPS location stop flag is set, the positioning process is terminated.

On the other hand, when it is determined that the GPS location function is not in the off state, that is, the GPS location function is in the on state, in step S18, the process returns to step S13 and the process from step S13 onwards is performed again.

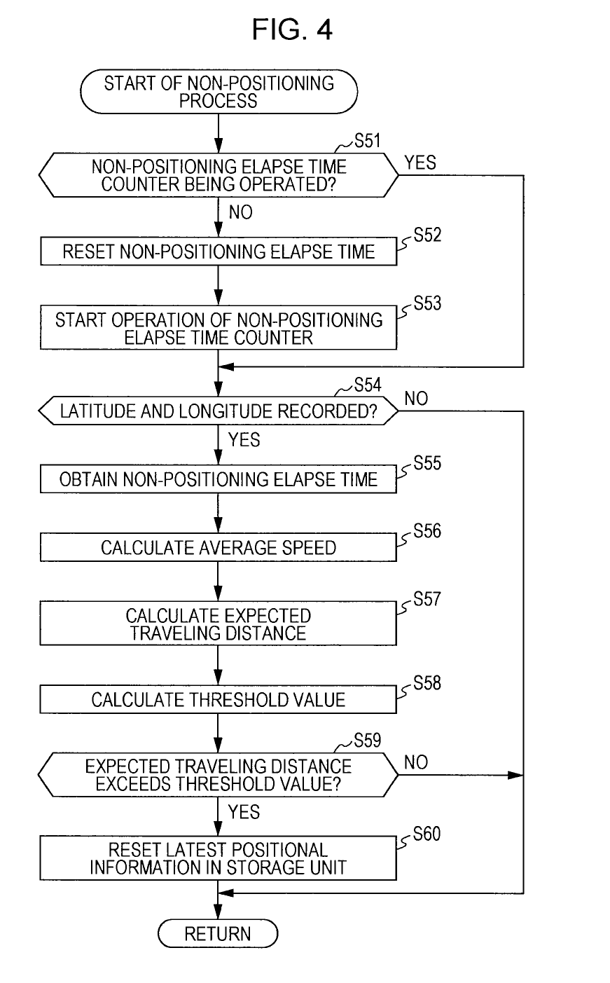

When it is determined that the GPS location is not appropriately performed in step S13, the process proceeds to step S21. In step S21, a non-positioning process is performed. The non-positioning process executed in step S21 will be described with reference to a flowchart illustrated in FIG. 4. A process in the flowchart illustrated in FIG. 4 is executed by the non-positioning processor 32.

### Non-Positioning Process

In step S51, it is determined whether the non-positioning elapse time counter is operated. The non-positioning elapse time counter is realized when the time counter 51 performs counting. Therefore, an operation in step S51 is performed by determining whether the time counter 51 performs counting. When the determination is negative in step S51, the process proceeds to step S52. In step S52, a non-positioning elapse time is reset. Specifically, in this case, a counting time of the time counter 51 is set to 0.

Thereafter, in step S53, the operation of the non-positioning elapse time counter is started. Specifically, in this case, the counting of the time counter 51 is started. The non-positioning elapse time counter is used to count a period of time in which the GPS location is not appropriately performed. The non-positioning elapse time counter operates non-stop while the GPS location is not appropriately performed so as to count the period of time.

In step S54, it is determined whether latitude and longitude has been stored in the storage unit 12. An operation in step S54 is also performed when it is determined that the non-positioning elapse time counter is being operated in step S51. Specifically, when the time counter 51 performs counting, the operation in step S54 is executed. In step S54, when it is determined that the latitude and the longitude (positional information) have been stored in the storage unit 12, the process proceeds to step S55.

In step S55, a non-positioning elapse time is obtained. Specifically, at this time point, the period of time counted by the time counter 51 is obtained by the expected traveling distance calculation unit 53 and the threshold value calculation unit 54. In step S56, the average speed calculation unit 52 calculates an average speed. The average speed is calculated by obtaining an average of a traveling speed of the user (the information processing apparatus 10) which has been obtained by the positioning.

In step S57, the expected traveling distance calculation unit 53 calculates an expected traveling distance. The expected traveling distance is obtained by estimating a distance obtained after a time point when the positioning is not performed. The expected traveling distance is obtained from the non-positioning elapse time and the average speed.

In step S58, the threshold value calculation unit 54 calculates a threshold value. The threshold value calculated by the threshold value calculation unit 54 is to be compared with the expected traveling distance. The threshold value is calculated in accordance with the non-positioning elapse time.

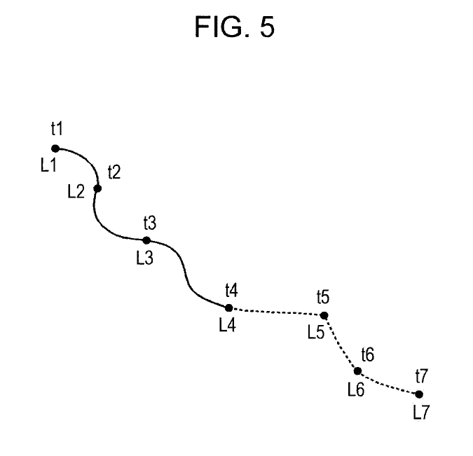

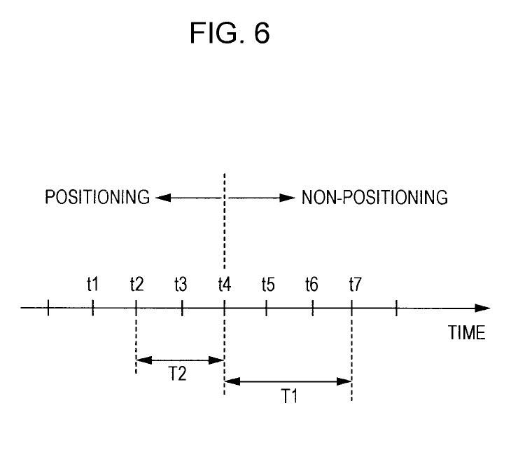

The process from step S55 to step S58 will be described with reference to FIGS. 5 and 6. FIG. 5 illustrates a locus of the user (the information processing apparatus 10) traveling. It is assumed that the user who positions in a position L1 at a time point t1 moves to a position L2 at a time point t2, moves to a position L3 at a time point t3, moves to a position L4 at a time point t4, moves to a position L5 at a time point t5, moves to a position L6 at a time point t6, and moves to a position L7 at a time point t7. Furthermore, it is assumed that the positioning is performed from the time point t1 to the time point t4 and the positioning is not performed from the time point t4 to the time point t7.

The positioning is performed at a predetermined time interval. Although it is assumed that the predetermined time interval is five minutes in the description of this embodiment, the time interval is not limited to five minutes. A state obtained after the movement is performed as illustrated in FIG. 5 and a positioning state is changed to a non-positioning state is represented in a time axis as illustrated in FIG. 6. The time points t1 to t7 have intervals of five minutes, and therefore, the time points t1 to t7 are arranged at regular intervals on the time axis. Positioning information is obtained before the time point t4 and the positioning is not performed after the time point t4. Furthermore, in this embodiment, it is assumed that the process of the flowchart illustrated in FIG. 4 is executed at the time point t7. It should be noted that the calculation of average speed, expected travel distance, and/or threshold comparison can be done on a remote device(s), such as one or more cloud servers. When using a connection to remote processing resources the estimating unit transmits times within time T2, and associated locations and/or travel speeds, and mode. The remote processing resources then calculate the average speed, and expected travel distance, and compare the expected travel distance to a threshold, and return the results to the local device. The comparison may also be done at the local device.

The operation in step S55 is executed at the time point t7, a period of time from the time point t4 to the time point t7 is obtained as the non-positioning elapse time. The non-positioning elapse time obtained in step S55 is determined as a time T1. Accordingly, the time T1 is represented as follows:

Time T1=Time Point t7−Time Point t4

In this case, since the positioning is performed every five minutes, the time T1 is 15 minutes. In step S55, the non-positioning elapse time, that is, the time T1 which is 15 minutes, is obtained.

Next, the calculation of the average speed will be described. The average speed is calculated using a time T2. The time T2 represents a mode which has been set when the non-positioning state is entered (at the time point t4 in this case) or represents a period of time denoted by speed per hour. The relationships below, for example, are set in advance.
Less than 10 km/h Walking Mode Time T2=10 min
10 km/h to 30 km/h exclusive Bicycle Mode Time T2=5 min
30 km/h to 50 km/h exclusive Motorbike Mode Time T2=3 min
50 km/h or more Car Mode Time T2=2 min

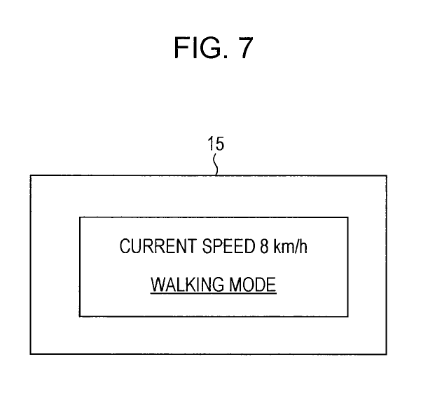

The speed per hour can be calculated using a distance between two points and a time when the positioning is performed, for example. Therefore, the speed per hour may be calculated and stored when the positioning is appropriately performed, and the time T2 may be set in accordance with the stored speed per hour when the positioning is stopped. Furthermore, a screen illustrated in FIG. 7 may be displayed in the display unit 15 to notify the user of a mode currently set.

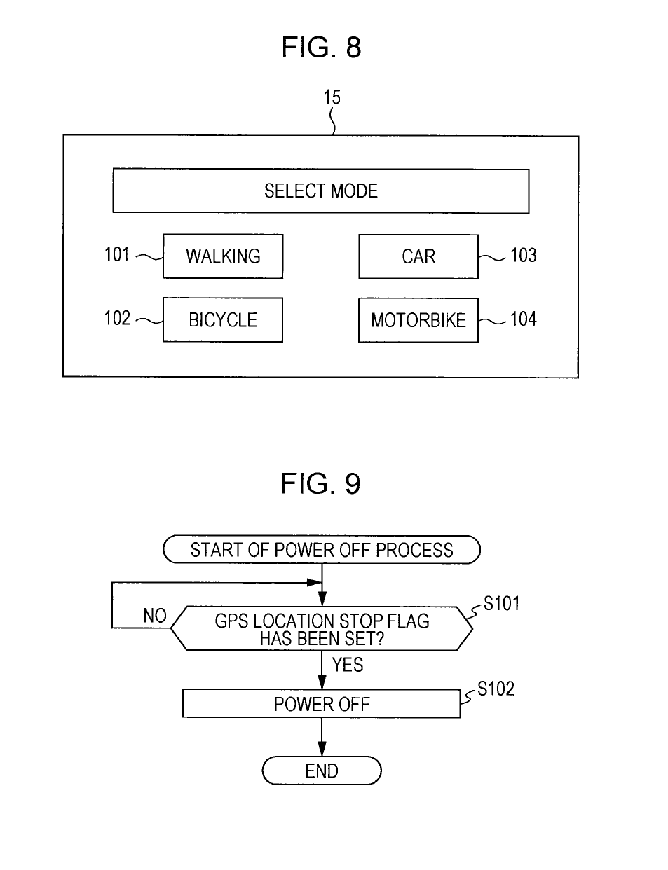

The example of the screen illustrated in FIG. 7 which is displayed in the display unit 15 displays a message “Current Speed 8 km/h Walking Mode”. The current speed which is a value calculated by the information processing apparatus 10 and a mode associated with the calculated value are displayed. The display of such a message prompts the user to check the mode while the positioning is not performed. Furthermore, when the user checks a mode and recognizes that an incorrect mode has been set, the screen illustrated in FIG. 8 may be displayed in the display unit 15 so that the user performs correction.

The screen example illustrated in FIG. 8 is displayed in the display unit 15 when the user is to select a mode. In the screen example illustrated in FIG. 8, an option 101 which is operated when a mode “walking” is to be selected, an option 102 which is operated when a mode “bicycle” is to be selected, an option 103 which is operated when a mode “car” is to be selected, and an option 104 which is operated when a mode “motorbike” is to be selected are displayed. A mode is set when the user selects, among these options, an option corresponding to a mode representing a state of the user, for example, the option 101 corresponding to a walking mode representing a state in which the user is walking.

Information on the mode set as described above may be constantly displayed in the display unit 15 as illustrated in FIG. 7 or may be displayed in the display unit 15 as illustrated in FIG. 7 when the user issues an instruction. Alternatively, the screen illustrated in FIG. 8 may be displayed in the display unit 15 when the information processing apparatus 10 is powered, for example, and a mode may be set when the user operates the operation unit 14 with reference to the screen.

Furthermore, in a case where the information processing apparatus 10 is employed in an apparatus which leads ways, which is mounted on a car, and which is referred to as a “car navigation system”, the car mode is set since the information processing apparatus 10 is mounted on the car. Moreover, in a case where the information processing apparatus 10 is employed in a portable navigation system which is portable and which has been developed provided that the apparatus is used while the user is walking, the walking mode is set. As described above, a predetermined mode may be set depending on a system including the information processing apparatus 10 so that the mode is not changed by the user or not changed in accordance with a result of measurement.

As described above, the mode is determined by calculating a speed per hour using positional information obtained from the user or the GPS location. Alternatively, a preset mode is determined. Then, the time T2 is determined in accordance with the determined mode and an expected traveling distance is calculated.

In this embodiment, a case where the walking mode is set at the time point t4 when the non-positioning state is entered will be described as an example. In the walking mode, the time T2 is set to 10 minutes. An average speed is obtained between the time point when the non-positioning state is entered and a time point the time T2 before the time point when the non-positioning state is entered. Referring to FIG. 6, since the time T2 is set to 10 minutes in this case, the time point t2 is specified as a time point 10 minutes before the time point t4. A speed between the time point t2 to the time point t4 is calculated as an average speed. Since the positioning is performed between the time point t2 to the time point t4, the average speed may be calculated in accordance with measured positional information.

Referring to FIG. 5, positional information at the time point t2 is the position L2, positional information at the time point t3 is the position L3, and positional information at the time point t4 is the position L4. Since the positional information is obtained when the positioning is performed, the positional information is stored in the storage unit 12.

An average speed in the time T2 is calculated from the positions L2 and L4 read from the storage unit 12. The average speed may be obtained by dividing a difference between the positions L2 and L4 by the time T2. The difference between the positions L2 and L4 is obtained in two ways. First, the position L4 is subtracted from the position L2 and an absolute value of a resultant value is determined as the difference. In this case, the difference corresponds to a distance of a straight line which connects the positions L2 and L4 to each other.

A case where the information processing apparatus 10 which positions in the position L2 at the time point t2 moves to the position L3 in the next time point t3 and moves to the position L4 in the time point t4 as illustrated in FIG. 5 may be considered. Since the position L3 is obtained while the positioning is performed, the position L3 may be obtained from positional information stored in the storage unit 12.

Therefore, a difference between the positions L2 and L3 may be obtained, a difference between the positions L3 and L4 may be obtained, and the differences may be added to each other so that a resultant value is determined as a distance used to obtain the average speed. In this case, the distance corresponds to a traveling path.

The straight distance or the distance corresponding to the traveling path is obtained and the obtained distance is divided by the time T2 so that the average speed is obtained. The average speed is thus obtained. For example, when the straight distance or the distance corresponding to the traveling path is calculated to be 1 km, the average speed is 6 km/h since the time T2 is 10 minutes.

When the obtained average speed is multiplied by the time T1 which is the non-positioning elapse time, an expected traveling distance may be calculated. Specifically, it is assumed that the user moves in an average speed obtained when the positioning is performed even while the positioning is not performed, and traveling distance is calculated by determining a period of time in which the user moves in the average speed and performing the multiplication. In the foregoing example, since the average speed of 6 km/h is calculated and the time T1 is 15 minutes, an expected traveling distance of 1.5 km (6×0.25) is obtained.

As described above, in step S57, the expected traveling distance is calculated by estimating a traveling distance at a time of the non-positioning state.

Note that, although the average speed in the period of time from a time point the time T2 before the time point when the non-positioning state is entered to the time point when the non-positioning state is entered is obtained in this embodiment, a time point (a time point t4 in the foregoing example) serving as a reference point of tracing back by the time T2 is not limited to the time point when the non-positioning state is entered. For example, the average speed may be calculated by calculating a traveling distance in a period of time corresponding to the time T2 in the period of time in which the positioning is performed. For example, a traveling distance in a period of time from the time point t1 to the time point t3 may be calculated so that the average speed is calculated.

Note that it is highly likely that an average speed obtained by calculating a traveling distance corresponding to the time T2 using the time point when the non-positioning state is entered as the reference time point matches an average speed in the non-positioning state, and therefore, it is highly likely that the expected traveling distance is obtained using a value close to the average speed in the non-positioning state.

The time T2 is set in accordance with a mode (traveling speed) at a time when the non-positioning state is entered as described above. It is considered that, as the traveling speed becomes high, for example, a difference between a position recorded when the non-positioning state is entered (a position recorded the last time when the positioning is performed) and a position in which the information processing apparatus 10 is actually located becomes large. However, since the time T2 is set in accordance with a mode (traveling speed) at the time when the non-positioning state is entered, both a case where the traveling speed is high and a case where the traveling speed is low are appropriately coped with. In other words, the expected traveling distance which is a distance in which it is expected that the information processing apparatus 10 is actually moved may be calculated irrespective of the traveling speed.

Although the local device may be integrated into a dedicated navigation device, it should also be recognized that the apparatus can be included in a smartphone, video recorder, or tablet computer, for example. Furthermore the non-positioning processor, for instance may be implemented in a downloadable app, which is executed on a smartphone or tablet computer that works autonomously, or with a remote computing resource.

Next, a calculation of the threshold value to be compared with the expected traveling distance will be described. The threshold value is calculated as below. First, a calculation method employed in a case of a low traveling speed such as a case where the walking mode is set will be described. In the walking mode or the like, a speed is assumed to be 5 km/h and a value obtained by multiplying a non-positioning elapse time (the time T1) by the walking speed is set as the threshold value.

In this case, a threshold value of 5 kilometers is obtained when the non-positioning elapse time (the time T1) is one hour, a threshold value of 2.5 kilometers is obtained when the non-positioning elapse time is half an hour, and a threshold value of approximately 83 meters is obtained when the non-positioning elapse time is one minute. As described above, the threshold value is obtained by estimating a speed per hour (a speed per minute) and multiplying the speed by the non-positioning elapse time. Note that, although the walking mode has been described as the example in this embodiment, also in each of the other modes, the threshold value is obtained by estimating a speed which is suitable for a corresponding one of the modes and multiplying the speed by the non-positioning elapse time (this method will be referred to as a “first calculation method”).

As another calculation method, first, a position at a time point the time T1 before the time point when the non-positioning state is entered is obtained. For example, when 15 minutes has been elapsed after the non-positioning state is entered, positional information obtained 15 minutes before the time point t4 (refer to FIGS. 5 and 6) is read from the storage unit 12. In the case of the example illustrated in FIG. 5, a time point the time T1 (15 minutes) before the time point t4 is the time point t1. The position corresponding to the time point t1 is the position L1. From the storage unit 12, the position L1 which is the positional information at the time point t1 and the position L4 which is the positional information at the time point t4 are read.

A difference between the position L1 and the position L4 is set as the threshold value. (This method is referred to as a “second calculation method”). Here, as with the case described with reference to FIG. 5, the difference between the positions L1 and L4 may be calculated as a straight distance or as a distance along a traveling path. For example, the straight distance may be calculated when the non-positioning elapse time is short (that is, when the non-positioning elapse time is equal to or smaller than a predetermined threshold value) whereas the distance along the traveling path may be calculated when the non-positioning elapse time is long.

The first calculation method may be employed in the walking mode and the second calculation method may be employed in the modes other than the walking mode. It is likely that an error of the first calculation method is large in some cases since a preset speed value is used. However, in a case of the walking mode, that is, a case where a traveling distance per hour is smaller than those in the other modes, it is considered that a small error occurs even if an error occurs. Therefore, the first calculation method may be employed in the walking mode whereas the second calculation method may be employed in the other modes.

After the threshold value is calculated in any one of the methods in step S58, the process proceeds to step S59. In step S59, it is determined whether the expected traveling distance exceeds the threshold value. When the determination is affirmative in step S59, the process proceeds to step S60. In step S60, the latest positional information stored in the storage unit 12 is reset.

The latest positional information is held (stored) as positional information in the non-positioning state. When the information processing apparatus 10 is incorporated in an image pickup apparatus, for example, positional information obtained and stored by the information processing apparatus 10 is used to specify a shooting location. When positioning is not performed in such shooting, the latest positional information at a time point immediately before the non-positioning state is entered (information in the location L4 at the time point t4 in FIG. 5, for example) may be used as positional information at a time of the shooting. However, since the positioning is not performed, the used positional information is not necessarily appropriate information.

In step S60, the resetting of the latest positional information stored in the storage unit 12 means a setting for not using the latest positional information as positional information for the non-positioning state. In other words, the resetting of the latest positional information in step S60 means a resetting (clearance) of the held positional information so that the positional information is not held. Therefore, when the determination is negative in step S59, the operation in step S60 is skipped.

When the operation in step S60 is skipped, the latest positional information stored in the storage unit 12 is not reset. Accordingly, a state in which the latest positional information is used as the positional information for the non-positioning state is maintained. On the other hand, when it is determined that the expected traveling distance is larger than the threshold value, the resetting is performed in the operation in step S60. Thereafter, the held positional information is set not to be used as the positional information for the non-positioning state (that is, the held positional information is deleted).

As described above, when the expected traveling distance exceeds the threshold value, the latest positional information among information stored in the storage unit 12 is set not to be used as the positional information for the non-positioning state. It is considered that the expected traveling distance exceeds the threshold value when a difference between a position corresponding to the latest positional information among the positional information stored in the storage unit 12 and an actual position is large.

By performing this process, the latest positional information among the positional information stored in the storage unit 12 is set not to be used as the positional information in the non-positioning state when an error is large. Accordingly, information having a large error is prevented from being used.

Note that the resetting (clearance) may be performed not only when the expected traveling distance exceeds the threshold value but also in cases below. For example, the resetting may be performed when an elapse time (the time T1) after the non-positioning state is entered corresponds to a certain period of time or exceeds the certain period of time. The certain period of time includes a case where a date is changed.

Alternatively, the resetting may be performed when a period of time corresponding to the non-positioning state becomes larger than a period of time corresponding to the positioning state. In other words, the resetting may be performed when the positional information is not included in the storage unit 12 at a time point the time T1 corresponding to the non-positioning state before the time point when the non-positioning state is entered (the time point t4).

After the non-positioning process is performed, the process proceeds to step S16 (in FIG. 3). The process from step S16 onwards has been described above, and therefore, a description thereof is omitted. However, since update of the GPS location is waited in step S16, even when the non-positioning process is performed, a state returns to a normal state when normal positioning becomes available.

In a case where the positioning state changes to the non-positioning state since the user temporarily enters a building, the non-positioning process is performed when the user is in the building and positional information obtained in the positioning state is used where appropriate. Thereafter, when the positioning becomes available since the user goes out of the building, positional information is obtained and the obtained positional information is used. This switching is appropriately performed.

Furthermore, in a case where the positioning state changes to the non-positioning state since the user gets on a vehicle such as a train, the non-positioning process is performed when the user is on the train and positional information obtained in the positioning state is used where appropriate. However, in the process described above, when the expected traveling distance exceeds the threshold value, the stored (held) positional information is not used. Accordingly, when a difference between actual positional information and the held positional information becomes large since a distance of traveling by the train becomes large, the held positional information is reset so as not to be used. After the user gets off the train and the positioning becomes available, a state in which reliable positional information is obtained may be entered.

### Process in Power Off State

An interrupting process is performed so that the information processing apparatus 10 is powered off while the positioning process or the non-positioning process is performed. The process performed when the power is to be turned off will be described with reference to a flowchart illustrated in FIG. 9.

When the user operates the operation unit 14 so as to issue an instruction for turning off the information processing apparatus 10, it is determined whether the GPS location stop flag has been set in step S101. The GPS location stop flag is set when the GPS location function is in the off state as described above. The GPS location stop flag is set in step S20 (in FIG. 3).

Referring back to the flowchart in FIG. 3, in step S20, the GPS location stop flag is set. The operation in step S20 is performed when it is determined that the GPS location function is in the off state in step S11. In this case, although the GPS location stop flag has been set since the GPS location function is in the off state, the GPS location stop flag is set again in step S20.

The operation in step S20 is also performed when it is determined that an instruction for stopping the GPS location has been issued in step S17, and therefore, the GPS location is stopped in step S19 or when it is determined that the GPS location function is in the off state in step S18, and therefore, the GPS location is stopped in step S19. In any case, when the GPS location is stopped, the GPS location stop flag is set in step S20.

Although, when the instruction for turning off the power is issued, it is determined whether the GPS location stop flag has been set in step S101 (in FIG. 9), a waiting state is maintained until it is determined that the GPS location stop flag has been set. While the waiting state is maintained, the process of the flowchart illustrated in FIG. 3 is continuously performed. Therefore, the power is not turned off until it is determined that the instruction for stopping the GPS location has been issued and the GPS location stop flag is set in step S20 after the operation in step S19.

When the GPS location stop flag is set, it is determined that the GPS location stop flag has been set in step S101 (in FIG. 9). Therefore, the process proceeds to step S102 and the information processing apparatus 10 is turned off. As described above, when the GPS location stop flag is set, the information processing apparatus 10 is turned off whereas when the GPS location stop flag is not set, the information processing apparatus 10 is not turned off.

During a state in which the information processing apparatus 10 is not turned off and the GPS location stop flag is not set, the process of the flowchart illustrated in FIG. 3 is performed, and in addition, the process of the flowchart illustrated in FIG. 4 is also performed depending on circumstances. Therefore, the positioning process (a process relating to an obtainment and storage of positional information) is continuously performed. For example, when the information processing apparatus 10 serves as a portion of the image pickup apparatus, functions relating to an obtainment and storage of positional information performed by the information processing apparatus 10 may be in on states while an image pickup function of the image pickup apparatus is in an off state. Accordingly, a user's needs such as a request for storing a traveling locus even though image capturing is not performed may be satisfied.

Note that, although the case where the GPS location stoop flag is set and the process is performed as described above has been described in this embodiment, the information processing apparatus 10 may be turned off when the power is turned off irrespective of whether the GPS location stop flag has been set.

### Other Configurations

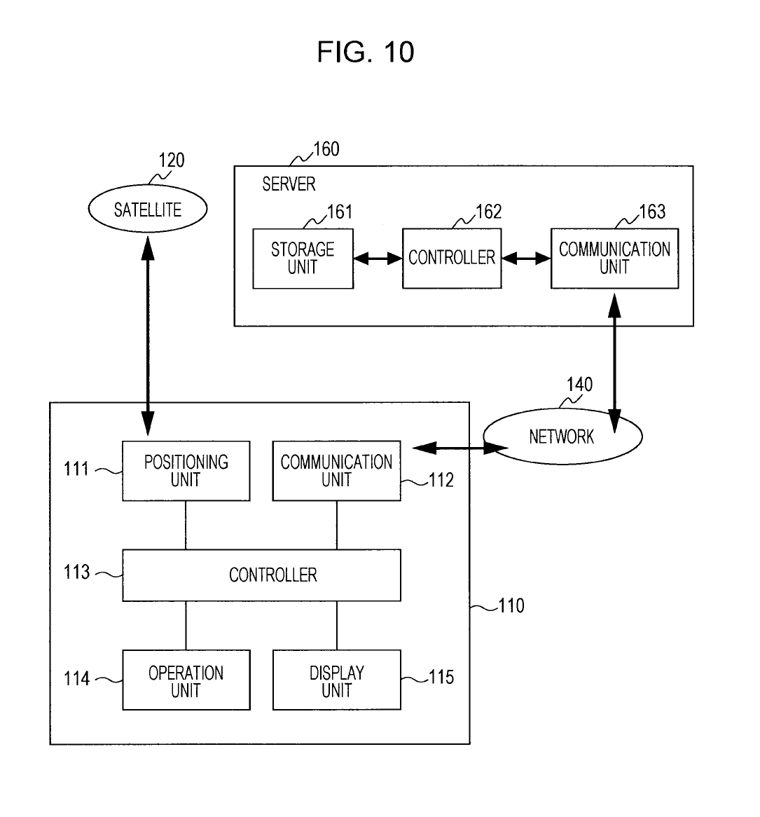

FIG. 10 is a diagram illustrating another configuration. In the configuration illustrated in FIG. 10, an information processing apparatus 110 communicates with a server 160 through a network 140. The information processing apparatus 110 includes a positioning unit 111, a communication unit 112, a controller 113, an operation unit 114, and a display unit 115. The positioning unit 111, the controller 113, the operation unit 114, and the display unit 115 may have configurations similar to the positioning unit 11, the controller 13, the operation unit 14, and the display unit 15, respectively, which are illustrated in FIG. 1. Here, descriptions of these units are omitted.

Specifically, the information processing apparatus 110 illustrated in FIG. 10 is different from the information processing apparatus 10 illustrated in FIG. 1 in that the storage unit 12 of the information processing apparatus 10 is replaced by the communication unit 112 and other configurations are the same as those of the information processing apparatus 10. The information processing apparatus 110 receives a signal supplied from a satellite 120 (GPS) by the positioning unit 111 and performs positioning. The communication unit 112 included in the information processing apparatus 110 supplies a result of the positioning to the server 160 through the network 140.

The server 160 includes a storage unit 161, a controller 162, and a communication unit 163. When receiving positional information from the information processing apparatus 110 through the network 140, the communication unit 163 included in the server 160 supplies the positional information to the controller 162. The controller 162 identifies the information processing apparatus 110 which supplies the positional information with reference to an ID or the like and stores the supplied positional information in the storage unit 161 in accordance with the identification.

In this way, when receiving the signal from the satellite 120, the information processing apparatus 110 determines a position of the information processing apparatus 110 and transmits a result of the determination to the server 160. The server 160 stores the positional information supplied from the information processing apparatus 110. Furthermore, the server 160 performs part of the process performed by the information processing apparatus 10 described above. Specifically, the server 160 stores, when the information processing apparatus 110 appropriately performs positioning, obtained positional information. Furthermore, the server 160 determines a traveling speed and a mode of the information processing apparatus 110 in accordance with the received positional information.

When the positioning is not appropriately performed, the information processing apparatus 110 transmits information representing that the positioning is not appropriately performed to the server 160. When receiving such information, the server 160 basically performs a process similar to the non-positioning process illustrated in FIG. 4. Specifically, the server 160 determines whether held positional information is to be cleared and calculates an expected traveling distance and a threshold value in order to perform the determination.

With this configuration, if the information processing apparatus 110 communicates with the server 160 even in the non-positioning state, storage of obtained positional information and the non-positioning process may be performed by the server 160. Furthermore, when the server 160 has higher capability than the information processing apparatus 110, a more specific expected traveling distance and a more specific threshold value may be calculated. Furthermore, in a case where the information processing apparatus 110 is incorporated in an image pickup apparatus, images and videos captured by the image pickup apparatus may be transmitted along with positional information to the server 160 and stored in the storage unit 161 of the server 160.

As described above, by employing this technique, even in a case where positioning is not appropriately performed since a signal is not received from a GPS (satellite) and therefore positional information previously obtained (held positional information) is used, an estimated traveling distance is calculated and the held positional information may be cleared when the estimated traveling distance is large.

Since the held positional information is cleared, when a difference between the held positional information and actual positional information is large, positional information having such an error may be prevented from being recorded. By performing control such that the positional information including an error is prevented from being recorded, reliability of the positional information to be recorded may be improved. Since a process of clearing the held positional information is performed without user's operation, usability is improved and user-friendliness is improved.

### Recording Medium

The series of processes described above may be executed by hardware or software. When the series of processes is executed by software, programs which constitute the software are installed in a computer. Examples of the computer include a computer incorporated in dedicated hardware and a general personal computer capable of executing various functions by installing various programs.

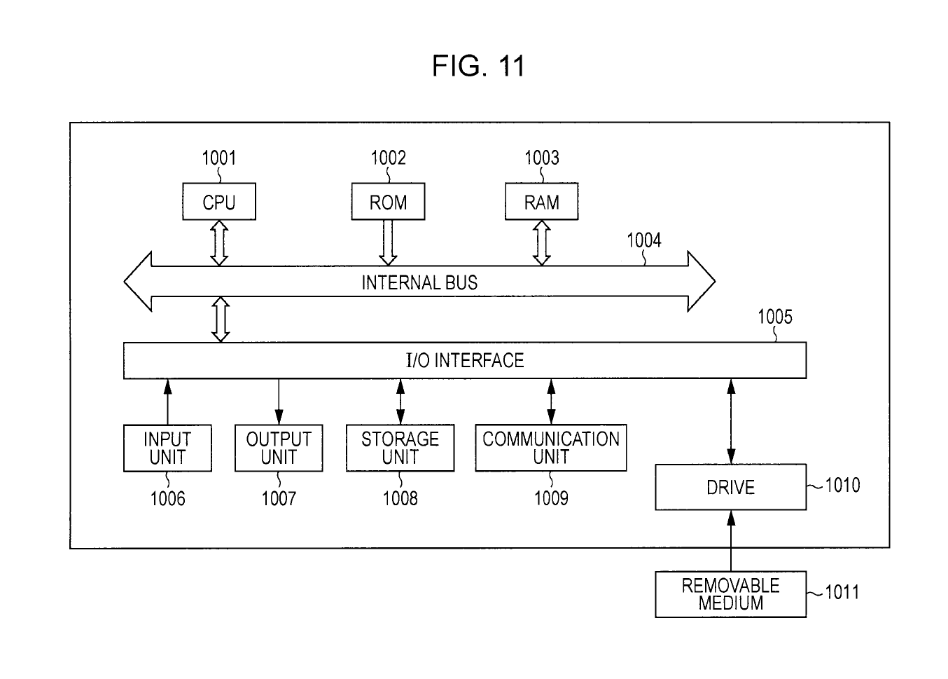

FIG. 11 is a block diagram illustrating a configuration of hardware of a computer which executes the series of processes by programs. In the computer, a CPU (Central Processing Unit) 1001, a ROM (Read Only Memory) 1002, and a RAM (Random Access Memory) 1003 are connected to one another through a bus 1004. Furthermore, an input/output interface 1005 is connected to the bus 1004. To the input/output interface 1005, an input unit 1006, an output unit 1007, a storage unit 1008, a communication unit 1009, and a drive 1010 are connected.

The input unit 1006 includes a keyboard, a mouse, and a microphone. The output unit 1007 includes a display and a speaker. The storage unit 1008 includes a hard disk and a nonvolatile memory. The communication unit 1009 includes a network interface. The drive 1010 drives a removable medium 1011 such as a magnetic disk, an optical disc, a magneto-optical disc, or a semiconductor memory.

In the computer configured as described above, the CPU 1001 loads programs stored in the storage unit 1008 into the RAM 1003 through the input/output interface 1005 and the bus 1004 and executes the programs to thereby perform the series of processes described above.

The programs to be executed by the computer (CPU 1001) may be provided by being recorded in the removable medium 1011 serving as a package medium, for example. Furthermore, the programs may be provided through a wired or wireless transmission medium such as a local area network, the Internet, or digital satellite broadcasting.

In the computer, the programs may be installed in the storage unit 1008 through the input/output interface 1005 by inserting the removable medium 1011 into the drive 1010. Furthermore, the programs may be installed in the storage unit 1008 after being received by the communication unit 1009 through a wired or wireless transmission medium. Alternatively, the programs may be installed in the ROM 1002 or the storage unit 1008 in advance.

Note that the programs executed by the computer may be processed in a time-series manner in an order described in this specification, may be processed in parallel, or may be processed at appropriate timings when the programs are called.

Furthermore, in this specification, the term “system” represents an entire apparatus including a plurality of devices.

Note that the technique is not limited to the foregoing embodiments and various modifications may be made without departing from the scope of this technique.

Note that this technique may have the configurations below.

In an information processing apparatus embodiment, the embodiment includes

a positioning unit configured to determine a position of the information processing apparatus;

a storage unit configured to store positional information obtained by the positioning unit;

an estimating unit configured to estimate, when it is determined that the positioning unit does not receive information to perform positioning, an estimated distance of a movement in a first period T1 in which the positioning is not performed; and

a controller configured to update the positional information stored in the storage unit when the estimated distance exceeds a threshold value corresponding to the first period T1.

According to one aspect of the embodiment, the estimating unit estimates the positional information from a calculated previous average speed over a second time period T2 that occurs when the positioning unit can determine the position.

According to another aspect of the embodiment, the estimating unit transmits positional information and speed information to a remote device and receives the estimated distance for the first time period T1.

According to another aspect of the embodiment, the estimating unit includes a consideration of a mode of transportation during the time period T2.

According to another aspect of the embodiment, said apparatus is included in a smartphone.

According to another aspect of the embodiment, said apparatus is included in a tablet computer.

According to another aspect of the embodiment, said apparatus is included in a video recorder.

According to another aspect of the embodiment, said estimating unit is implemented as a downloaded app executed on a processor.

According to another aspect of the embodiment, the controller obtains the threshold value by multiplying a preset speed by the first period T1.

According to another aspect of the embodiment, the controller sets the threshold value as a difference between a first position represented by positional information stored at a first time point when the positioning is not performed by the positioning unit and a second position represented by positional information stored at a second time point that comes before the first time point.

According to another aspect of the embodiment, the estimating unit calculates a value of a difference between a first position represented by positional information stored at a first time point when the positioning performed by the positioning unit is stopped and a second position represented by positional information stored at a second time point which comes before the first time point by a second period, the second period being associated with a traveling speed at the first time point, and calculates an average speed by dividing the difference value by a difference between the first time point and second time point, and

the average speed is multiplied by the first period T1 so that the distance is estimated.

According to another aspect of the embodiment, the difference value is obtained by calculating a distance obtained by connecting the first position and the second position by a straight line as the difference value or by adding differences among positions corresponding to positional information stored in a period of time from the first time point to the second time point to one another.

According to another aspect of the embodiment, a plurality of modes are set depending on a traveling speed and different second periods are set for individual modes of the plurality of modes, and

the estimating unit determines an individual mode corresponding to a traveling speed at the first time point and estimates the distance using the second period set in the individual mode.

According to another aspect of the embodiment, when it is determined that the distance does not exceed the threshold value, latest positional information stored in the storage unit is stored in the storage unit as positional information obtained in the first period T1.

According to another aspect of the embodiment, the threshold value is obtained by multiplying a preset speed by the first period.

According to another aspect of the embodiment, the threshold value is a value of a difference between a first position represented by positional information stored at a first time point when the positioning is not performed by the positioning unit and a second position represented by positional information stored at a second time point which comes before the first time point by the first period.

According to another aspect of the embodiment, the difference value is obtained by calculating a distance obtained by connecting the first position and the second position by a straight line as the difference value or by adding differences among positions corresponding to positional information stored in a period of time from the first time point to the second time point to one another.

According to another aspect of the embodiment, the controller removes the latest positional information from the storage unit when the first period becomes equal to or larger than a predetermined value.

According to an information processing method embodiment, the method includes

determining with a positioning unit a position of an information processing apparatus;

storing in a storage unit positional information obtained by the positioning unit;

when it is determined that the positioning unit does not receive information to perform positioning, estimating with an estimating unit an estimated distance of a movement in a first period T1 in which the positioning is not performed; and

updating with a controller the positional information stored in the storage unit when the estimated distance exceeds a threshold value corresponding to the first period T1.

According to a non-transitory computer program product embodiment, the computer program product has computer readable instructions stored thereon that when executed by a processor perform a method in an information processing apparatus, said method includes

determining with a positioning unit a position of an information processing apparatus;

storing in a storage unit positional information obtained by the positioning unit;

when it is determined that the positioning unit does not receive information to perform positioning, estimating with an estimating unit an estimated distance of a movement in a first period T1 in which the positioning is not performed; and

updating with a controller the positional information stored in the storage unit when the estimated distance exceeds a threshold value corresponding to the first period T1.

What is claimed is:

1. An information processing apparatus comprising:
a positioning unit configured to determine a position of the information processing apparatus;
a storage unit configured to store positional information obtained by the positioning unit;
an estimating unit configured to estimate, when it is determined that the positioning unit does not receive information to perform positioning, an estimated distance of a movement in a first period T1 in which the positioning is not performed; and
a controller configured to update the positional information stored in the storage unit when the estimated distance exceeds a threshold value corresponding to the first period T1.

2. The information processing apparatus of claim 1, wherein the estimating unit estimates the positional information from a calculated previous average speed over a second time period T2 that occurs when the positioning unit can determine the position.

3. The information processing apparatus of claim 1, wherein the estimating unit transmits positional information and speed information to a remote device and receives the estimated distance for the first time period T1.

4. The information processing apparatus of claim 2, wherein the estimating unit includes a consideration of a mode of transportation during the time period T2.

5. The information processing apparatus of claim 1, wherein said apparatus is included in a smartphone.

6. The information processing apparatus of claim 1, wherein said apparatus is included in a tablet computer.

7. The information processing apparatus of claim 1, wherein said apparatus is included in a video recorder.

8. The information processing apparatus of claim 1, wherein said estimating unit is implemented as a downloaded app executed on a processor.

9. The information processing apparatus of claim 1, wherein the controller obtains the threshold value by multiplying a preset speed by the first period T1.

10. The information processing apparatus of claim 1, wherein the controller sets the threshold value as a difference between a first position represented by positional information stored at a first time point when the positioning is not performed by the positioning unit and a second position represented by positional information stored at a second time point that comes before the first time point.

11. The information processing apparatus according to claim 1,
wherein the estimating unit calculates a value of a difference between a first position represented by positional information stored at a first time point when the positioning performed by the positioning unit is stopped and a second position represented by positional information stored at a second time point which comes before the first time point by a second period, the second period being associated with a traveling speed at the first time point, and calculates an average speed by dividing the difference value by a difference between the first time point and second time point, and
the average speed is multiplied by the first period T1 so that the distance is estimated.

12. The information processing apparatus according to claim 11,
wherein the difference value is obtained by calculating a distance obtained by connecting the first position and the second position by a straight line as the difference value or by adding differences among positions corresponding to positional information stored in a period of time from the first time point to the second time point to one another.

13. The information processing apparatus according to claim 11,
wherein a plurality of modes are set depending on a traveling speed and different second periods are set for individual modes of the plurality of modes, and
the estimating unit determines an individual mode corresponding to a traveling speed at the first time point and estimates the distance using the second period set in the individual mode.

14. The information processing apparatus according to claim 1,
wherein, when it is determined that the distance does not exceed the threshold value, latest positional information stored in the storage unit is stored in the storage unit as positional information obtained in the first period T1.

15. The information processing apparatus according to claim 1,
wherein the threshold value is obtained by multiplying a preset speed by the first period.

16. The information processing apparatus according to claim 1,
wherein the threshold value is a value of a difference between a first position represented by positional information stored at a first time point when the positioning is not performed by the positioning unit and a second position represented by positional information stored at a second time point which comes before the first time point by the first period.

17. The information processing apparatus according to claim 16
wherein the difference value is obtained by calculating a distance obtained by connecting the first position and the second position by a straight line as the difference value or by adding differences among positions corresponding to positional information stored in a period of time from the first time point to the second time point to one another.

18. The information processing apparatus according to claim 1,
wherein the controller removes the latest positional information from the storage unit when the first period becomes equal to or larger than a predetermined value.

19. An information processing method comprising:
determining with a positioning unit a position of an information processing apparatus;
storing in a storage unit positional information obtained by the positioning unit;
when it is determined that the positioning unit does not receive information to perform positioning, estimating with an estimating unit an estimated distance of a movement in a first period T1 in which the positioning is not performed; and
updating with a controller the positional information stored in the storage unit when the estimated distance exceeds a threshold value corresponding to the first period T1.

20. A non-transitory computer program product having computer readable instructions stored thereon that when executed by a processor perform a method in an information processing apparatus, said method comprising:
determining with a positioning unit a position of an information processing apparatus;
storing in a storage unit positional information obtained by the positioning unit;
when it is determined that the positioning unit does not receive information to perform positioning, estimating with an estimating unit an estimated distance of a movement in a first period T1 in which the positioning is not performed; and
updating with a controller the positional information stored in the storage unit when the estimated distance exceeds a threshold value corresponding to the first period T1.
